(19) United States
(12) Patent Application Publication
(10) Pub. No.: US 2016/0237356 A1
(43) Pub. Date: Aug. 18, 2016

(54) ZEOLITE CATALYST COMPOSITION

(71) Applicant: COOL PLANET ENERGY SYSTEMS, INC., Camarillo, CA (US)

(72) Inventors: Rajashekharam MALYALA, Camarillo, CA (US); Vern S. TRAXLER, Simi Valley, CA (US); Timothy Alan THOMPSON, Ventura, CA (US); Mark L. JARAND, Newbury Park, CA (US)

(21) Appl. No.: 15/029,185

(22) PCT Filed: Oct. 24, 2014
(86) PCT No.: PCT/US14/62256

§ 371 Date: Apr. 13, 2016

Related U.S. Application Data
(60) Provisional application No. 61/895,905, filed on Oct. 25, 2013.

(51) Int. Cl. C10G 3/00; C10L 1/04; B01J 35/10; B01J 29/40; B01J 21/16

(52) U.S. Cl. CPC C10G 3/49; B01J 29/40; B01J 21/16; B01J 35/1038; B01J 35/1061; C10L 1/04; C10L 2200/0469; C10G 2300/1011

(57) ABSTRACT

A low density zeolite composition includes a zeolite in the amount of less than 80 wt % of total composition and a crystalline non-zeolite metal oxide-containing binder. The composition has a pore volume of at least 0.4 mL/g and an average meso-pore diameter of 20-500 Å, and macroporosity with average pore diameter greater than 500 Å.

### RELATED APPLICATIONS

This application claims the benefit of priority to co-pending U.S. Application Ser. No. 61/895905 filed Oct. 25, 2013, entitled “Zeolite Catalyst Composition,” which is hereby incorporated in its entirety by record.

### INCORPORATION BY REFERENCE

All patents, patent applications and publications cited herein are hereby incorporated by reference in their entirety in order to more fully describe the state of the art as known to those skilled therein as of the date of the invention described herein.

### BACKGROUND

The present disclosure relates generally to catalysts for use in making renewable fuels, and more particularly to catalysts for the chemical conversion of biomass to renewable fuels and other useful chemical compounds.

Zeolites have been known for some time as catalysts in hydrocarbon conversions. Zeolites are crystalline aluminosilicates with a characteristic porous structure made up of a three dimensional network of SiO₄ and AIO₄ tetrahedra cross-linked by shared oxygen atoms with a variety of structures and aluminum contents. The catalytic activity of zeolites relies on their acidity. Non-tetravalent atoms within the tetrahedral array, such as trivalent aluminum, gallium or boron, create a positive charge deficiency, which can be compensated by a cation such as H+. In addition, the pores and channels through the crystalline structure of the zeolite enable the materials to act as selective molecular sieves particularly if the dimensions of the channels fall within a range which enables the diffusion of large molecules to be controlled. Thus, acidic zeolites can be used as selective catalysts.

Systems describing the conversion of biomass into fuels and other useful chemical compounds has been previously described. Some such methods involve subjecting volatile components derived from biomass to one or more catalysts such as dehydration catalysts, aromatization catalysts, and gas upgrading catalysts. The processing of the complex organic gaseous products collected from biomass decomposition is typically inefficient due to the unavailability of catalysts with the appropriate selectivity and reactivity.

### SUMMARY

A zeolite catalyst composition containing micro, meso and macroporosity suitable for use in the production of fuel from gaseous decomposition products of biomass is provided.

The catalyst composition and the process for preparing same in accordance with the present invention result in a narrow size distribution of the larger mesopores and macropores, thereby providing increased pore volume and improved access to interior portions of the catalyst material.

In one aspect, a low density zeolite composition includes a zeolite in the amount of less than 80 wt % of total composition; and a crystalline non-zeolite metal oxide-containing binder, wherein the composition has a pore volume of at least 0.4 mL/g and an average mesopore diameter of 20-500 Å, and wherein the composition has macroporosity with average pore diameter greater than 500 Å.

In one or more embodiments, the low density zeolite composition demonstrates the same fuel production efficiency as a catalyst composition using 80 wt % of the same zeolite in a composition lacking macroporosity.

In any of the preceding embodiments, the low density zeolite composition demonstrates a lower durene production during fuel production as compared to a catalyst using 80 wt % of the same zeolite in a composition lacking macroporosity.

In any of the preceding embodiments, the zeolite is ZSM-5.

In any of the preceding embodiments, the non-zeolite metal-oxide-containing binder is selected from the group consisting of silica, titania, zirconia, talc, magnesia, alumina, calcium oxide, kaolin, and combinations of these oxides.

In any of the preceding embodiments, the non-zeolite metal-oxide-containing binder is kaolin clay.

In any of the preceding embodiments, the non-zeolite metal-oxide-containing binder further includes alumina.

In any of the preceding embodiments, the composition has a bulk density of 25-40 lb/ft³.

In any of the preceding embodiments, the zeolite in the amount of 50-70 wt % of total composition.

In another aspect, a precursor to a low density zeolite composition includes a zeolite in the amount of less than 80 wt % of total composition; and a crystalline non-zeolite metal-oxide-containing binder; and a sacrificial organic compound having particle size and burn out properties selected to provide the desired mesopores and macropore size and pore distribution.

In any of the preceding embodiments, the sacrificial organic compound is selected from the group consisting of cellulose, starch, polyethylene, PTFE, latex, polyethylene glycol (PEG), acicular carbons, carbon black, activated carbon, graphite, carboxylic acids such as oxalic acid, and lingo-sulfonic acid and combinations thereof.

In any of the preceding embodiments, the sacrificial organic compound includes cellulose.

In any of the preceding embodiments, the sacrificial organic compound includes acicular carbon.

In any of the preceding embodiments, the non-zeolite metal-oxide-containing binder is selected from the group consisting of silica, titania, zirconia, talc, magnesia, alumina, calcium oxide, kaolin, and combinations of these oxides.

In any of the preceding embodiments, the non-zeolite metal-oxide-containing binder includes kaolin clay.

In any of the preceding embodiments, the non-zeolite metal-oxide-containing binder further includes alumina.

In any of the preceding embodiments, the alumina is an alumina sol.

In another aspect, a method of making a renewable fuel includes receiving a gaseous product comprising oxygen, hydrogen and carbon in a catalytic reactor including the low density zeolite catalyst of any of the preceding embodiments; and contacting the gaseous product with the low density zeolite catalyst to obtain a renewable fuel, said renewable fuel containing less than 10 wt % durene.

In any of the preceding embodiments, the gaseous product is obtained from the pyrolysis of a biomass.

In any of the preceding embodiments, the gaseous product further comprises a co-solvent.

In one or more embodiments, the co-solvent is one of more of methanol, ethanol and dimethyl ether.

In another aspect, a method of making a low density zeolite catalyst composition includes providing a precursor to the zeolite catalyst composition according to any of the preceding enbodiments, and heating the precursor to remove the sacrificial organic material and introduce macroporosity.

### BRIEF DESCRIPTION OF THE DRAWINGS

The invention is described with reference to the following figures, which are presented for the purpose of illustration only and are not intended to be limiting.

FIG. 1 is a scanning electron photograph of a low bulk density zeolite catalyst composition according to one or more embodiments. Inset picture is an enlarged view of the catalyst surface (scale bar=500 nm).

FIG. 2 is a photograph of a commercially available zeolite catalyst composition. Inset picture is an enlarged view of the catalyst surface (scale bar=10,000 nm).

FIG. 3 is a gas chromatography/mass spectroscopy (GC/MS) trace of the various components of a raw fuel prepared using a low bulk density zeolite catalyst composition according to one or more embodiments.

FIG. 4 is a gas chromatography/mass spectroscopy (GC/MS) trace of the various components of a raw fuel prepared using a conventional zeolite catalyst composition.

FIGS. 5A-5B are gas chromatography/mass spectroscopy (GC/FID) traces of the various components of a raw fuel prepared using a low bulk density zeolite catalyst composition according to one or more embodiments.

### DETAILED DESCRIPTION

A low bulk density zeolite catalyst composition is described. The catalyst composition comprises a zeolite having a microporous crystalline phase distributed in a non-zeolite binder in a configuration that provides mesoporosity and macroporosity. The zeolite catalyst compositions containing micro, meso and macroporosity described herein according to one or more embodiments can be used in catalysis. Pores are commonly classified into three groups depending on their sizes: micro (<2 nm); meso (2-50 nm); and macro (>50 nm).

In one or more embodiments, the catalyst composition has a narrow size distribution of mesopore-scale pore volume. The mesopore-scale pore volume can have an average pore diameter of 20 Å to 500 Å and can have an average pore volume of 0.2-0.8 mL/g. In some embodiments, the low bulk density zeolite catalyst composition can have an average mesopore diameter of 50 Å to 100 Å, and an average pore volume of at least 0.4 mL/g. The catalyst composition also includes a macropore-scale pore volume having an average pore diameter of greater than 5000 Å. The bulk density of the zeolite catalyst composition is in the range of 25-40 lb/ft³ (or 400-650 k/m³). In other embodiments, the surface area is in the range of 200-700 m²/g and in particular about 300-350 m²/g.

In contrast, a commercially available zeolite extrudate containing 80% zeolite has a bulk density of at least 600 k/m³ and a surface area of greater than 375 m²/g. Thus the structure of this catalyst appears to be microporous; it lacks the sufficient amounts of mesoporosity and macroporosity provided by the low bulk density zeolite catalyst composition described herein. As is discussed in detail below, the low bulk density zeolite catalyst composition according to one or more embodiments demonstrates catalytic conversion of oxyhydrocarbon feedstock to liquid fuel that is comparable or superior to commercially available zeolite catatyts.

In one or more embodiments, the low bulk density zeolite composition has a crush strength of 1 to 1.5 lb/mm, a compact bulk density of 25-40 lb/ft³, a BET surface area of 300-350 m²/g, an average porosity of 0.4 mL/g (for<2000 Å pores), an average mesopore diameter of 20-500 Å, and an average macroporous diameter of greater than 5000 Å.

In some embodiments, the zeolite makes up no more than 80 wt % of the final catalyst composition, and in a particular embodiment, the zeolite makes up about 55-70 wt %, or about 60-65 wt %, of the final catalyst composition. This can be compared to commercially available zeolite catalyst compositions, which typically contain more than 80 wt % zeolite for the same fuel production and catalyst cycle time. Both samples result in similar fuel yields, although the amount of zeolite is higher in the commercial sample (see tables on pages 15 and 16 below), so that the catalyst of the current invention requires less material for the same fuel yield.

The particular zeolite for inclusion in the catalyst composition can be those typically used in liquid fuel production from oxyhydrocarbon feedstocks. The zeolite can be selected with consideration of the particular chemical reactions and the natures of feedstock contemplated. The zeolite provides microporous crystalline walls with desirable active sites, which are accessible to organic molecules of interest due to the large volume of macropore-sized channels in the composition. In one or more embodiments, the zeolite can be ZSM5, beta-, modernite-, and zeolite-Y. In particular, the zeolite can be ZSM-5, an aluminosilicate zeolite belonging to the pentasil family of zeolites. ZSM-5 has a high silicon to aluminum ratio and is acidic with the use of protons to keep the material charge-neutral. The acidity of ZSM-5 can be used for acid-catalyzed reactions such as hydrocarbon isomerization and the alkylation of hydrocarbons.

The non-zeolite binder material can be selected to impart desirable thermal and mechanical properties, among others, to the zeolite catalyst composition. In one or more embodiments, the non-zeolite binder material is an inorganic oxide, such as silica, titania, zirconia, talc, magnesia, alumina, calcium oxide, kaolin, and combinations of these oxides. In one or more embodiments, the non-zeolite binder material is an alumina-containing crystalline material. In particular, the non-zeolite binder material can be a clay, e.g., a kaolin clay. The non-zeolite binder can further include alumina (aluminum oxide). In one or more embodiments, the low bulk density zeolite catalyst is a blend of ZSM-5 zeolite with kaolin clay and alumina oxide as a binder. The relative amounts of zeolite and non-zeolite binder can vary. The amount of zeolite in the catalyst composition can vary from 50 to 80% and the amount of non-zeolite binder can vary from 10% to 40%.

In another aspect, a precursor to a mesoporous and macroporous, low bulk density zeolite composition is provided. In addition to the above noted zeolite catalyst and alumina-containing binder, the precursor formulation also includes pore formers that create macro-porosity in the final extruded catalyst which are advantageous for performance of the catalyst. Also, precursors to the above mentioned materials can be used. For example, colloidal alumina sols, and suspensions of any of above mentioned oxides can be used in the precursor, which are converted into the binder with subsequent processing, as described herein below.

According to one or more embodiments, porosity can be introduced into zeolite catalyst using a sacrificial template method. A templating material is initially homogenously distributed in a continuous matrix of the heat stable phase (e.g., the zeolite and the non-zeolite binder materials) and is thereafter removed to result in a porous material. According to one or more embodiments, a low bulk density zeolite catalyst composition is prepared by mixing a zeolite catalyst, an alumina-containing material, a sacrificial organic material having particle size and burn out properties selected to provide the desired mesopore and macropore size and pore distribution. Thus the templating agents targets to form pores preferably greater than 500 Å.

Typical sacrificial organic materials include organic materials, such as dense or hollow polymer beads, or particles. Within this broad range of suitable materials, suitable materials include cellulose, starch, polyethylene, PTFE, latex, polyethylene glycol (PEG), acicular carbons, carbon black, activated carbon, graphite, carboxylic acids such as oxalic acid, and lingo-sulfonic acid and combinations thereof.The size, shape and arrangement of the sacrificial organic material offers significant versatility to independently tailor the porosity, pore size distribution and pore morphology. The organic compound used to generate the meso and macro pore-size pore volume is preferably selected, based upon the microporous zeolite material being used, so as to provide pore volume of appropriate size and shape. It should be appreciated that the amount of meso and macro pore-sized pore volume provided depends at least in part upon the amount of sacrificial organic material included in the precursor. Further, the size of the meso and macro pore-sized pores depends at least in part on the particle or bead size of the sacrificial organic material. Thus, the amount and size of meso and macro pore-sized pore volume can be selectively controlled by selecting the proper amount and size of sacrificial organic material. Exemplary particle size can range from about 1 μm to 250 μm, or preferably between about 5 μm and 180 μ. In other embodiments, the particle size can be much smaller, particularly when using carbon as the sacrificial material. The following table includes a summary of some exemplary materials and their properties.

Note: Water born

| | | | cc/100 gm | | |
|---|---|---|---|---|---|
| | Particle size | | oil | M²/gm | |
| Burnout Materials | microns | Angstroms | absorption | NSA | STSA |
| Starch, Corn | 6 to 21 | 160,000 | | | |
| Cellulose, | 50 | 500,000 | | | |
| microcrystaline | | | | | |
| Kobo Beads, | 40 | 400,000 | | | |
| Cello Beads D50 | | | | | |
| Kobo Beads, | 100 | 1,000,000 | | | |
| Cello Beads D100 | | | | | |
| Kobo Beads, | 175 | 1,750,000 | | | |
| Cello Beads D200 | | | | | |
| Dura Tech, | | | | | |
| Phenolic | | | | | |
| Microballons | | | | | |
| Polyethylene, | 53-75 | | | | |
| sigma, 434272 | | | | | |
| Polyethylene, | not | | | | |
| sigma, 429015 | disclosed | | | | |
| Polyethylene, | 35 | 350,000 | | | |
| sigma, 468096 | | | | | |
| Polyethylene, | 180 | 1,800,000 | | | |
| sigma, 434264 | | | | | |
| PTFE, sigma, | 100 | 1,000,000 | | | |
| 468118 | | | | | |
| PTFE, sigma, | | | | | |
| 665800, disp | | | | | |
| in H2O | | | | | |
| Poly(isobutyl) | | | | | |
| methacrylate, | | | | | |
| 445754 | | | | | |
| CoPoly- | 50 | 500,000 | | | |
| methacrylate/ | | | | | |
| Ethylene gylc | | | | | |
| Latex Rovene 6101 | | | | | |
| Latex Rovene 6066 | | | | | |
| Polyethylene | | | | | |
| Glyc, 1,000 mw | | | | | |
| Polyethylene | | | | | |
| Glyc, 3,400 mw | | | | | |
| Polyethylene | | | | | |
| Glyc, 4,000 mw | | | | | |
| Polyethylene | | | | | |
| Glyc, 10,000 mw | | | | | |

| | | Angstroms | | | |
|---|---|---|---|---|---|
| | | Mean | cc/100 gm | | |
| | | Particle | oil | M²/gm | |
| Carbons | micron | size | absorption | NSA | STSA |
| CanCarb N990 | 0.280 | 2800 | | 9 | |
| Raven 410 powder/ | 0.100 | 1010 | 68 | 26 | 26 |
| Columbian | | | | | |
| N650/Continental | 0.040 | 400 | 120.1 | 40 | 37.5 |
| carbon | | | | | |
| Raven 1060 | 0.030 | 300 | 50 | 66 | 65 |
| SolTex 100 | 0.042 | 420 | | 75 | |
| Raven 1040 | 0.028 | 280 | 100 | 90 | 86 |
| Raven 1250 | 0.020 | 200 | 60 | 113 | 102 |
| N234/Continental | 0.020 | 200 | 129.2 | 118.7 | 109.9 |
| carbon | | | | | |
| Raven 1255 | 0.021 | 210 | 66 | 122 | 119 |
| Evonik Printex 90 | | | 95 | 300 | |
| Evonik FW20 | | | 620 | 550 | |
| Raven 5000 Ultra | 0.008 | 80 | 95 | 583 | 350 |
| II Powder | | | | | |
| Graphites | | | | | |
| Sigma graphite | 7 to 11 | 70,000- | | | |
| 7-11 mu | | 110,000 | | | |
| Sigma | | | | | |
| graphite −20 | | | | | |
| to 84 mesh | | | | | |

The zeolite catalyst, alumina-containing material and sacrificial organic material are combined to obtain a paste of a consistency suitable for further post-processing, such as molding or extruding. Also, the binder materials may be provided in part in colloidal form so as to facilitate extrusion of the bound components. The mixture may also be combined with other materials, used as diluents or glidants to assist in the powder processing. It may be advantageous to precombine the powder ingredients. The combined powder ingredients can be sieved to reduce agglomeration and provide a uniform particle size.

In accordance with the invention, the resulting paste can be formed into a desired shape and then heated to form the crystalline composition and burn out the sacrificial organic material, thereby introduce macroporosity and/or mesoporosity into the composition. Calcine temperatures are preferably kept below a temperature known to degrade or modify the catalytic properties of the zeolite. In exemplary embodiments, the precursor is heated to temperatures in the range of 300-700° C., and preferably in the range of 500-600° C. The solidified crystalline microporous zeolite composition contains a meso and macro pore-sized pore volume having the desired narrow pore-sized distribution.

The material prepared in accordance with the invention is particularly useful as a catalyst for the generation of renewable liquid fuels. In one or more embodiments, it can be used for the production of desired aromatics such as benzene, toluene, and xylene (BTX) and other substituted aromatic fuels. The low density zeolite catalyst can be used with any carbon-hydrogen-oxygen-containing feedstock, particularly those used in the art to manufacture liquid fuels. Exemplary feedstocks include methanol, ethanol, dimethyl ether (DME) and pyrolysis gases from biomass.

The low density zeolite catalyst according to one or more embodiments is particularly useful in the transformation of pyrolysis gases from biomass into liquid fuel. The composition of pyrolysis gases can be complex and typically includes a range of oxygenated organic molecules, many having a size and/or molecular weight that is larger than conventional feedstocks such as methanol, ethanol and dimethyl ether (DME). In catalysts limited to meso-porosity, pyrolysis gases may not be able to diffuse into the zeolite catalyst in order to gain access the active sites. The zeolitic sites of the low density zeolite catalyst according to one or more embodiments are accessible to the more complex and larger molecules of the pyrolysis fuel through the larger macro pore volume.

In one or more embodiments, the low density zeolite catalyst according to one or more embodiments can be used for the production of desired aromatics such as benzene, toluene, and xylene (BTX) and other substituted aromatic fuels from the gaseous decomposition products generated during degradation of biomass, e.g., biovapors and light gases. In one or more embodiments, the the gaseous decomposition products generated during degradation of biomass can be mixed with co-solvents for the catalytic conversion process. Exemplary co-solvents include methanol, ethanol and dimethoxy ethanol.

It has been surprisingly discovered that the low density zeolite catalyst composition produces a liquid fuel product that contains less than 10% durene, and preferably less than 2% durene. Durene is a substance with a high melting point (79° C.) and its levels are typically reduced to those specified under gasoline product guidelines. The production of large amounts of durene, e.g., greater than 2% is considered undesirable as it is above the amount permissible in fuel formulations. Durene content is reduced by treating the liquid fuel prior to blending into product gasoline. Thus, products containing high levels of durene require an additional processing step to reduce the durene to acceptable levels, thereby significantly increasing the processing costs to usable fuel. The liquid fuels processed using the low density zeolite catalyst according to one or more inventions does not require additional processing as its during content is less than 2%. Simplifying a gas to liquids process by combining multiple steps into fewer reactors leads to increased yield and efficiency. While not being bound by any particular mode of operation, it is believed that the reduced durene content arises from the higher diffusivity to larger organic molecules afforded by the macroporosity.

The invention is illustrated in the following examples, which are not intended to be limiting of the invention and are presented solely for illustrative purposes.

### EXAMPLE 1

### Preparation of a Low Bulk Density Zeolite Composition

A method of preparation of a typical batch size of 500 grams of dry powder input is described.

| Formulation | wt % | Notes |
|---|---|---|
| 1. Zeolyst CBV8014 | 57 | Zeolite |
| 2. Kamin PolyGloss 90 | 25 | Kaolin |
| 3. Disperal 23N4 80 | 10 | 20% solution (colloid sol) |
| 4. Corn Starch | 4 | |
| 5. Cellulose, Microcrystalline | 4 | Alfa#A17730 |

| | |
|---|---|
| 6. Water | As needed for proper dough consistency |

The amount of water is determined using the following procedure. Separately, a small test batch is made to determine the amount of water that is needed to make proper dough. The amount of water can vary due to variability in the zeolite batch, and or moister levels in the starting materials. Water is added slowly until a stiff dough is formed. It should be the consistency of bread dough or workable molding clay. Once the desired consistence is achieved, the amount of water needed in the larger bulk batch can be determined based on the amount of water used in the test batch.

To prepare the larger bulk batch, only the dry ingredients are mixed, being sure to break up any small hard lumps as larger agglomerates can interfere later in the extrusion process.

The mixed dry power is sieved through a 2 or 3 mm sieve. Mixing at low speed the two liquids, alumina colloid sol and water, are added. The mixture is mixed until the dough has fully formed.

There are various systems for dough extrusion as known by those skilled in the art of extrusion technology. The catalyst should be a diameter of about ⅛″ (3.2 mm) and the length can be about 1 cm.

The extruded pellets are then calcined to burn out the sacrificial organic compound and form the binder. Laboratory furnaces are programed for ramp of 10 degrees a minute, with maximum temperature of 550° C. and hold time at 550° C. for 8 hours. The temperature preferably is no greater than 700° C., in order to avoid damage to the catalyst brought about by thermal degradation of the zeolite. Static ovens are used with ambient air atmosphere with some slow drafting or exchange of air. Organic pore formers and any ammonia left on the zeolite catalyst precursor are burnt via air oxidation. After calcination, the extrudates are bright white and without dark areas of left over organic carbon residues. The extrudates are cooled, sieved of dust and bottled up for storage until use. Batches are sampled for laboratory testing and QC qualification.

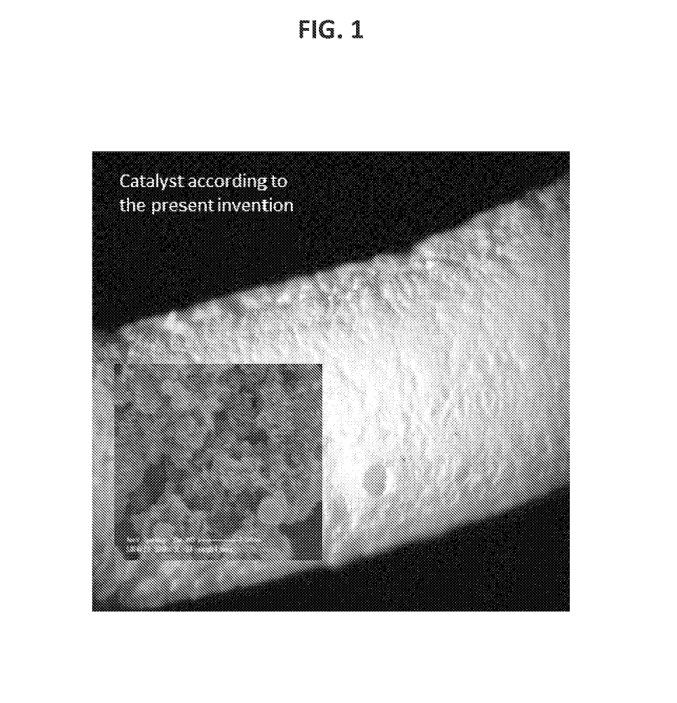

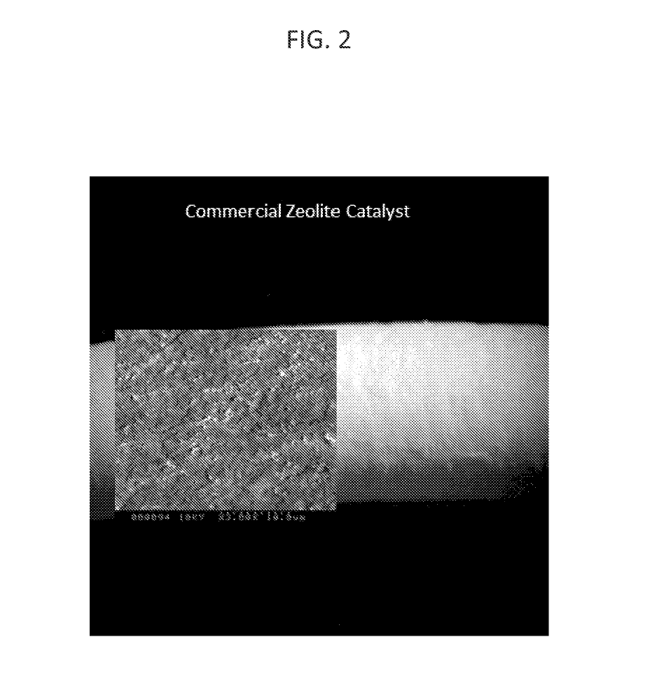

FIG. 1 is a photograph of a low bulk density zeolite composition made according to the above procedure. The extrudate shows a high level of macro and mesoporosity and is demonstrably less dense and more porous than the commercially available ZSM-5 zeolite catalyst, illustrated in the photograph in FIG. 2. The low density zeolite composition has a crush strength of 1 to 1.5 lb/mm, a compact bulk density of 25-40 lb/ft³, a BET surface area of 300-350 m²/g, an average porosity of 0.4 mL/g (for <2000 Å pores) and an average pore diameter of 50-100 Å.

### EXAMPLE 2

### Experiments on Activity Measurements of BTX Catalyst

### General Catalysis Set Up

Experiments were performed in a vertical reactor system. The vertical reactor system has a batch pyrolyzer that is coupled to either a single catalytic reactor or multiple catalytic reactors in series. The catalytic reactor is followed by an ice chilled condenser and a gas-liquid separator.

The raw fuel and process water are collected & separated. The light gases from the condenser are recirculated back into the catalytic reactor, with the use of a compressor. Light gas recirculation flow rate into the BTX reactor was approximately 3-4 CFH. The unit operated between 7-8 psi and pressure was controlled by a solenoid valve arrangement placed after the condenser. As the reaction progressed, the light gases accumulated in the reactor beyond 8 psi were vented into the exhaust.

The flow rate of these purged light gases was not measured.

The single reactor can be replaced by multiple reactors in series when needed. The catalyst in such multiple reactors can be the same catalyst or different catalysts. When multiple reactors are used, they can be operated at the same temperature or at different temperatures. When multiple catalytic reactors are used, the effluent from each reactor is condensed, with liquid product being separated and the non-condensable gaseous product being introduced in to the subsequent catalytic reactor for further fuel production.

A batch pyrolyzer with single reactor configuration was used to evaluate the BTX catalyst with light gas recirculation as mentioned above. Biomass used in this work is ground corn cobs with a moisture content of 7.5%. The pyrolysis chamber is typically loaded with 200g of corn cobs. Pyrolysis of biomass occurs from 225° C. to 425° C. in 4 hours during which the co-reagent is also run. The unit is run for an additional hour at 425° C. without any co-reagent to drive off any residuals in the pyrolysis chamber and the catalytic reactor.

Dimethyl Ether (DME) was used as co-reagent along with the pyrolysis vapors from the pyrolzyer. Other co-reagents that can be used are hydrocarbons such C1 to C7 carbon containing hydrocarbons, oxygenated hydrocarbons such as methanol, ethanol, propanol, isopropanol, butanol, isobutanol, sorbitol, iso-sorbide, acetic acid, acetone, glycerine. The co-reagent can be a single compound or a mixture of multiple compounds. The co-reagent, pyrolysis vapors, and recirculation gases were pre-mixed and pre-heated before they entered the catalytic reactor. N₂ (at 0.1 SCFH) is used as carrier gas at all times to help drive the pyrolysis vapors into the catalytic reactor. N₂ is preheated to 300° C. before it enters the pyrolysis chamber. Pyrolysis of biomass occurs from 225° C. to 425° C. in 4 hours during which the co-reagent is also run. The unit is run for an additional hour at 425° C. without any co-reagent to drive off any residuals in the pyrolysis chamber and the catalytic reactor.

The catalytic reactor, which converts the pyrolysis vapor and co-reagent to hydrocarbons, was loaded with 130 grams of BTX catalyst for each set of experiments. After a set of experiments is complete (i.e., after about 3 days of tests), the catalyst is removed and subject to manual regeneration from which the coke information is deduced. Thus, the amount of coke burnt is cumulative for those set of 4 runs. The output from the condenser is fuel and process water which is separated, measured & subject for further analysis.

Both raw and distilled fuels are analyzed by GC and GCMS for fuel composition. Density measurements were performed for both raw and distilled fuels. For each experiment, the % fuel yield is then calculated as the amount of raw fuel obtained in grams divided by the total input in grams (biomass+co-reagent). After each run, biochar is collected from the pyrolysis chamber and weighed. The % biochar is then calculated as the weight of remaining char in grams divided by the input biomass in grams (typically 200 grams). The catalyst is removed from the reactor after a set of 4 experiments and is manually regenerated. The catalyst is regenerated at 550° C. for 8 hours in static ovens. From the weights of catalyst before and after catalyst regeneration, the amount of coke burnt is deduced. The % Coke based on catalyst or input biomass can then be calculated.

### Catalysis Using Low Density BTX Catalyst Composition.

The BTX catalyst used in this example was made as described in Example 1 and was used as a catalyst in the conversion of gaseous components from the pyrolysis of biomass into benzene, toluene and xylene (BTX) fraction. It had 57% zeolite ZSM-5 material. The remaining material is Kaolin and alumina binder. This catalyst had a surface area of 250-350 m²/g. The compact bulk density of this catalyst was 0.57 g/cm³. A magnified picture of the catalyst extrudate according to the present invention is shown in FIG. 1. The microscopic picture reveals that the material is loosely packed when compared to the commercial catalyst and the presence of macro and meso porosity in addition to ZSM-5 microporosity in the extruded catalyst.

Three experiments were performed as described in example 2 after which the catalyst was removed from the reactor and regenerated. Two such experimental sets are presented in the table below. In one set of four experiments, there was no recycle of light gases. In another set of experiments there was recycle of light gases similar to example 2. The amount of fuel and char obtained is shown in table below:

| | ZSM5 content | Light Gas | | | | Fuel | % Yield | |
|---|---|---|---|---|---|---|---|---|
| | in the | Recirculation | | | DME Fed, | Generated | (output wt/input | Char, |
| Catalyst Used | Catalyst | (Yes/No) | VRS run # | Run date | grams | mL | wt) * 100 | grams |
| Cool planet | 57% | No | Day 1, VRS128 | Dec. 14, 2011 | 228 | 88 | 17.3% | 60 |
| Catalyst (⅛th | | | Day 2, VRS129 | Dec. 15, 2011 | 230 | 86 | 16.8% | 64 |
| inch extrudates) | | | Day 3, VRS130 | Dec. 16, 2011 | 230 | 79 | 15.4% | 58.5 |
| Cool Planet | 57% | Yes | Day 1, VRS 290 | Mar. 20, 2013 | 202 | 78 | 16.3% | 56 |
| Catalyst (⅛th | | | Day 2, VRS 291 | Mar. 21, 2013 | 199 | 97 | 20.4% | 53 |
| inch extrudates) | | | Day 3, VRS 292 | Mar. 22, 2013 | 199 | 97 | 20.4% | 53 |

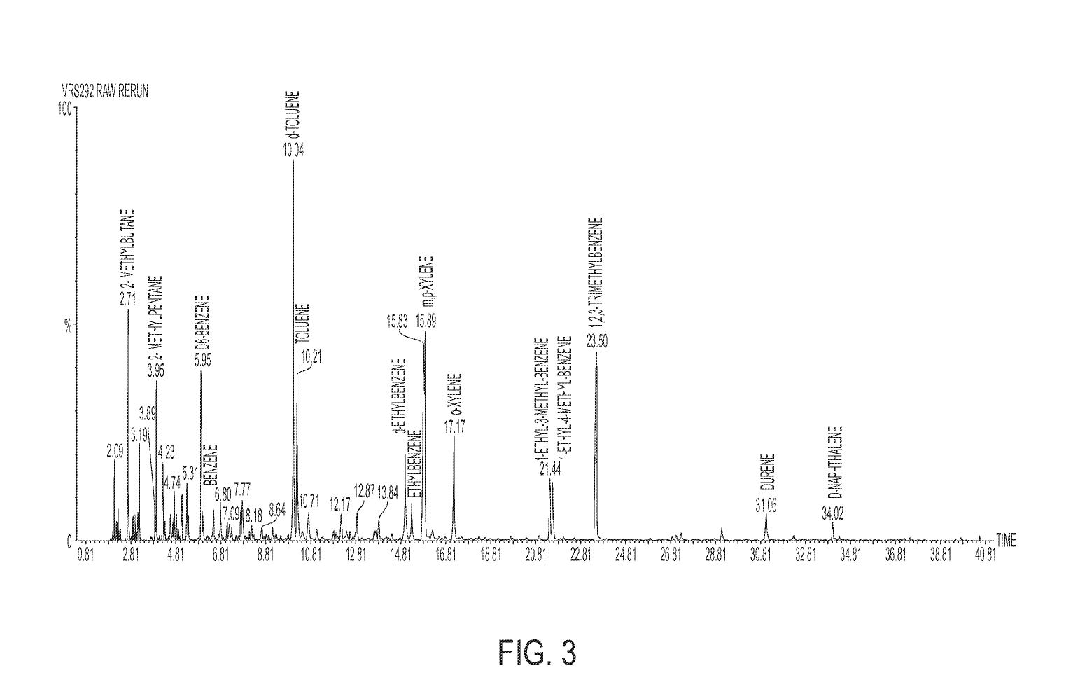

From the above table, it appears that recirculation of light gases into the BTX reactor help improve liquid fuel yield, due to a recirculation or space velocity change. typical GCMS spectrum of the liquid fuel obtained using this low bulk density catalyst is showing in FIG. 3. The spectrum reveals that the fuel is rich in aromatics. It also reveals a lower percentage of durene. The amount of durene formed was calculated to be 1.79 wt % in the liquid fuel. Lower durene levels are much desired.

### Comparative Example Using High Density BTX Catalyst.

The BTX catalyst used in this example is a commercial BTX catalyst that is ⅛th inch diameter and approximately 1 cm long extruded catalyst. It had 80% zeolite ZSM-5 material. The remaining is expected to be alumina binder. The bulk density of this catalyst was 0.65-0.75 g/cm3.This catalyst had a surface area of 375-425 m²/g. A magnified picture of the catalyst extrudate is shown in FIG. 2. The microscopic picture of this catalyst reveals that the material is packed compactly and the absence of macroporosity in the extruded catalyst.

Three experiments were performed as per example 2 before the catalyst was removed from the reactor and regenerated. The amount of fuel and char obtained is shown in table below:

| | ZSM5 content | Light Gas | | | | Fuel | % Yield | |
|---|---|---|---|---|---|---|---|---|
| | in the | Recirculation | | | DME Fed, | Generated | (output wt/input | Char, |
| Catalyst Used | Catalyst | (Yes/No) | VRS run # | Run date | grams | mL | wt) * 100 | grams |
| Commercial | 80% | Yes | Day 1, VRS 286 | Mar. 14, 2013 | 194 | 86 | 18.3% | 56 |
| Catalyst (⅛th | | | Day 2, VRS 287 | Mar. 15, 2013 | 201 | 78 | 16.3% | 54 |
| inch extrudates) | | | Day 3, VRS 288 | Mar. 18, 2013 | 195 | 84 | 17.9% | 58 |

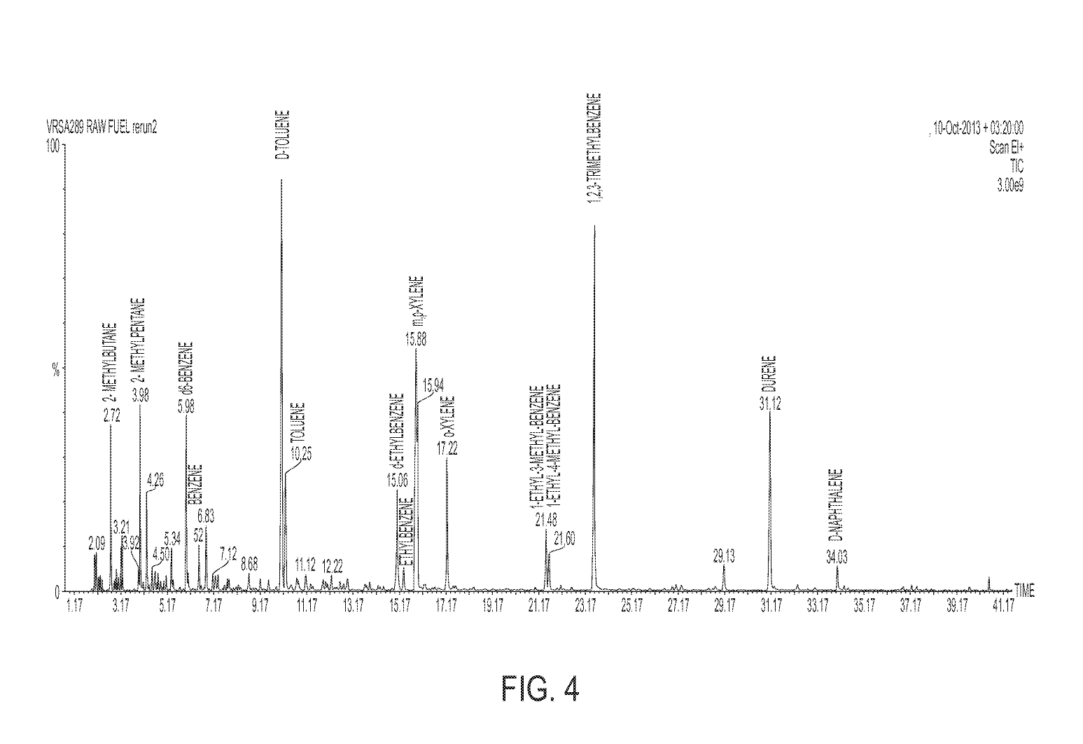

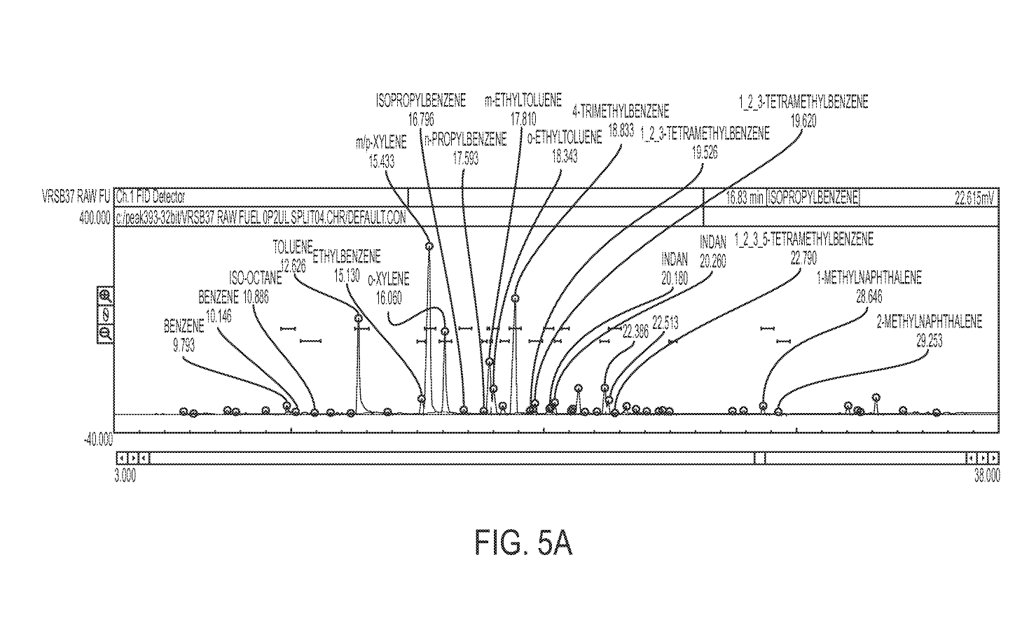

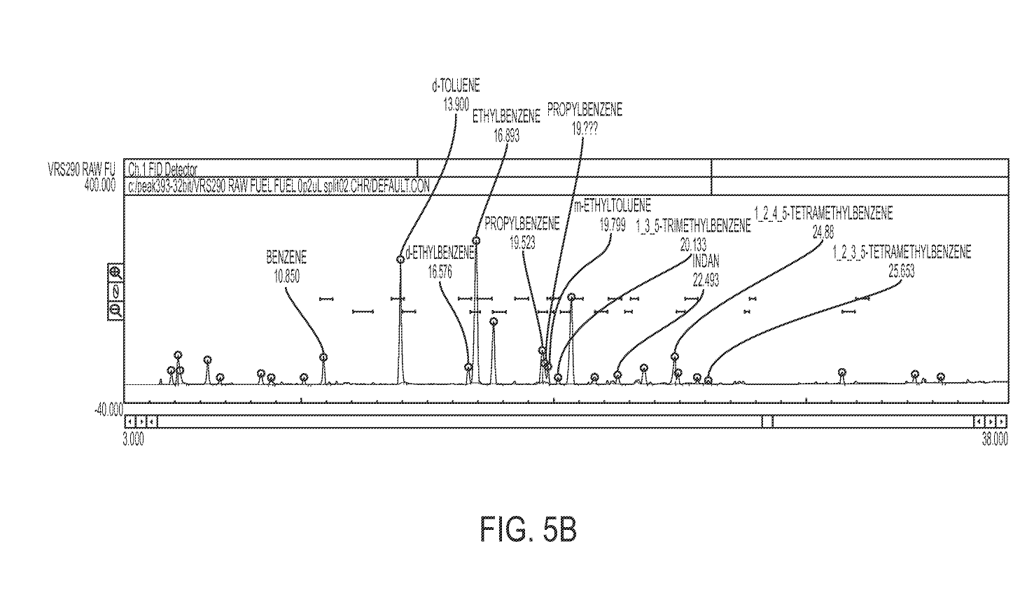

A typical GCMS spectrum of the liquid fuel using such a commercial BTX catalyst is shown in FIG. 4. The fuel obtained is significantly rich in aromatics. It also reveals the presence of durene and calculated to be at 10.96 wt % in the liquid fuel. Higher levels of durene in aromatic liquid fuel are undesirable.

As used herein, the term ‘biomass’ includes any material derived or readily obtained from plant sources. Such material can include without limitation: (i) plant products such as bark, leaves, tree branches, tree stumps, hardwood chips, softwood chips, grape pumice, sugarcane bagasse, switchgrass; and (ii) pellet material such as grass, wood and hay pellets, crop products such as com, wheat and kenaf. This term may also include seeds such as vegetable seeds, fruit seeds, and legume seeds.

The term ‘biomass’ can also include: (i) waste products including animal manure such as poultry derived waste; (ii) commercial or recycled material including plastic, paper, paper pulp, cardboard, sawdust, timber residue, wood shavings and cloth; (iii) municipal waste including sewage waste; (iv) agricultural waste such as coconut shells, pecan shells, almond shells, coffee grounds; and (v) agricultural feed products such as rice straw, wheat straw, rice hulls, com stover, com straw, and corn cobs.

The singular forms “a”, “an” and “the” include plural reference unless the context clearly dictates otherwise.

As used herein the term “about” is used herein to mean approximately, roughly, around, or in the region of. When the term “about” is used in conjunction with a numerical range, it modifies that range by extending the boundaries above and below the numerical values set forth.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims.

What is claimed is:

1. A low density zeolite composition, comprising:
a zeolite in the amount of less than 80 wt % of total composition; and
a crystalline non-zeolite metal oxide-containing binder,
wherein the composition has a pore volume of at least 0.4 mL/g and an average mesopore diameter of 20-500 Å, and
wherein the composition has macroporosity with average pore diameter greater than 500 Å.

2. The zeolite composition of claim 1, wherein the low density zeolite composition demonstrates the same fuel production efficiency as a catalyst composition using 80 wt % of the same zeolite in a composition lacking macroporosity.

3. The zeolite composition of claim 1, wherein the low density zeolite composition demonstrates a lower durene production during fuel production as compared to a catalyst using 80 wt % of the same zeolite in a composition lacking macroporosity.

4. The composition of claim 1, wherein the zeolite comprises ZSM-5.

5. The composition of claim 1, wherein the non-zeolite metal-oxide-containing binder is selected from the group consisting of silica, titania, zirconia, talc, magnesia, alumina, calcium oxide, kaolin, and combinations of these oxides.

6. The composition of claim 5, wherein the non-zeolite metal-oxide-containing binder comprises kaolin clay.

7. The composition of claim 6, wherein the non-zeolite metal-oxide-containing binder further comprises alumina.

8. The composition of claim 1, wherein the composition has a bulk density of 25-40 lb/ft³.

9. The composition of claim 1, wherein the zeolite in the amount of 50-70 wt % of total composition.

10. A precursor to a low density zeolite composition, comprising:
a zeolite in the amount of less than 80 wt % of total composition; and
a crystalline non-zeolite metal-oxide-containing binder; and
a sacrificial organic compound having particle size and burn out properties selected to provide the desired mesopores and macropore size and pore distribution.

11. The precursor of claim 10, wherein the sacrificial organic compound is selected from the group consisting of cellulose, starch, polyethylene, PTFE, latex, polyethylene glycol (PEG), acicular carbons, carbon black, activated carbon, graphite, carboxylic acids such as oxalic acid, and lingo-sulfonic acid and combinations thereof.

12. The precursor of claim 10, wherein the sacrificial organic compound comprises cellulose.

13. The precursor of claim 10, wherein the sacrificial organic compound comprises acicular carbon.

14. The precursor of claim 10, wherein the non-zeolite metal-oxide-containing binder is selected from the group consisting of silica, titania, zirconia, talc, magnesia, alumina, calcium oxide, kaolin, and combinations of these oxides.

15. The precursor of claim 14, wherein the non-zeolite metal-oxide-containing binder comprises kaolin clay.

16. The precursor of claim 15, wherein the non-zeolite metal-oxide-containing binder further comprises alumina.

17. The precursor of claim 16, wherein the alumina comprises an alumina sol.

18. A method of making a renewable fuel, comprising:
receiving a gaseous product comprising oxyen, hydrogen and carbon in a catalytic reactor comprising the low density zeolite catalyst of claim 1; and
contacting the gaseous product with the low density zeolite catalyst to obtain a renewable fuel, said renewable fuel containing less than 10 wt % durene.

19. The method of claim 18, wherein the gaseous product is obtained from the pyrolysis of a biomass.

20. The method of claim 18, wherein the gaseous product comprises methanol, ethanol and dimethyl ether.
